(19) United States
(12) Patent Application Publication
(10) Pub. No.: US 2009/0172114 A1
(43) Pub. Date: Jul. 2, 2009

(54) SYSTEM AND METHOD FOR SERVER-SIDE INTERRUPTION MANAGEMENT

(75) Inventors: Hema Srikanth, Raleigh, NC (US); Patrick Joseph O'Sullivan, Ballsbridge (IE); Brian Douglas Gallagher, West Newton, MA (US); Robert James Mullin, Hollis, NH (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/967,765

(22) Filed: Dec. 31, 2007

(51) Int. Cl. G06F 15/16

(52) U.S. Cl. 709/206

(57) ABSTRACT

A method and computer program product for determining that a user of a client electronic device is in do-not-interrupt mode. A message directed to the user is routed to a server-based storage queue for subsequent delivery.

### TECHNICAL FIELD

This disclosure relates to interruption management and, more particularly, to multi-modal interruption management.

### BACKGROUND

The electronic workplace today is continuously changing by allowing employees to collaborate and have team meetings in various ways, including instant messaging and web conferencing. Instant messaging has become and will continue to be a prevalent way of managing communications at a workplace. Instant messaging chat session may improve operational efficiencies, as they allow network users to collaborate and communicate freely around the world with minimal or no cost.

Unfortunately, instant messaging sessions may be unwelcomed interruptions at certain times, as they require a user to shift focus away from the current task they are working on (which may adversely impact productivity). Additionally, the unwelcomed nature of these interruptions may be intensified when a user is executing other applications (e.g., web conferencing applications that share a desktop or Microsoft PowerPoint™ in a “presentation” mode), wherein the interruption may be visible to all participants involved.

### SUMMARY OF DISCLOSURE

In a first implementation, a method includes determining that a user of a client electronic device is in do-not-interrupt mode. A message directed to the user is routed to a server-based storage queue for subsequent delivery.

One or more of the following features may be included. The message may be an instant message. Routing a message directed to the user to a server-based storage queue for subsequent delivery may include storing the instant message in an instant message server-based storage queue.

The message may be a text message. Routing a message directed to the user to a server-based storage queue for subsequent delivery may include storing the text message in a text message server-based storage queue.

The message may be a voicemail message. Routing a message directed to the user to a server-based storage queue for subsequent delivery may include storing the voicemail message in a voicemail message server-based storage queue.

The message may be an email message. Routing a message directed to the user to a server-based storage queue for subsequent delivery may include storing the email message in an inbox of an email system.

A sender of the message directed to the user may be notified that the user of the client electronic device is in do-not-interrupt mode. Notifying a sender may include one or more of: generating a notification instant message and providing the notification instant message to the sender of the message directed to the user; generating a notification text message and providing the notification text message to the sender of the message directed to the user; generating a notification email message and providing the notification email message to the sender of the message directed to the user; and generating a notification voice mail message and providing the notification voice mail message to the sender of the message directed to the user.

If it is determined that the user of the client electronic device is no longer in do-not-interrupt mode, one or more messages stored in the server-based storage queue may be retrieved, thus defining one or more retrieved messages. The one or more retrieved messages may be provided to the user.

The rendering of an onscreen indicator associated with the message directed to the user may be prohibited while the user is in do-not-interrupt mode. The onscreen indicator may be chosen from the group consisting of: a text message received onscreen indicator; an instant message received onscreen indicator; and an email received onscreen indicator.

In another implementation, a computer program product resides on a computer readable medium that has a plurality of instructions stored on it. When executed by a processor, the instructions cause the processor to perform operations including determining that a user of a client electronic device is in do-not-interrupt mode. A message directed to the user is routed to a server-based storage queue for subsequent delivery.

One or more of the following features may be included. The message may be an instant message. Routing a message directed to the user to a server-based storage queue for subsequent delivery may include storing the instant message in an instant message server-based storage queue.

The message may be a text message. Routing a message directed to the user to a server-based storage queue for subsequent delivery may include storing the text message in a text message server-based storage queue.

The message may be a voicemail message. Routing a message directed to the user to a server-based storage queue for subsequent delivery may include storing the voicemail message in a voicemail message server-based storage queue.

The message may be an email message. Routing a message directed to the user to a server-based storage queue for subsequent delivery may include storing the email message in an inbox of an email system.

A sender of the message directed to the user may be notified that the user of the client electronic device is in do-not-interrupt mode. Notifying a sender may include one or more of: generating a notification instant message and providing the notification instant message to the sender of the message directed to the user; generating a notification text message and providing the notification text message to the sender of the message directed to the user; generating a notification email message and providing the notification email message to the sender of the message directed to the user; and generating a notification voice mail message and providing the notification voice mail message to the sender of the message directed to the user.

If it is determined that the user of the client electronic device is no longer in do-not-interrupt mode, one or more messages stored in the server-based storage queue may be retrieved, thus defining one or more retrieved messages. The one or more retrieved messages may be provided to the user.

The rendering of an onscreen indicator associated with the message directed to the user may be prohibited while the user is in do-not-interrupt mode. The onscreen indicator may be chosen from the group consisting of: a text message received onscreen indicator; an instant message received onscreen indicator; and an email received onscreen indicator.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an interruption management process coupled to a distributed computing network;

FIG. 2 is a diagrammatic view of a desktop sharing application and an onscreen indicator rendered by e.g., the instant messaging server application of FIG. 1;

FIG. 3 is a diagrammatic view of a configuration window for the interruption management process of FIG. 1; and

FIG. 4 is a flowchart of the interruption management process of FIG. 1;

Like reference symbols in the various drawings indicate like elements.

### DETAILED DESCRIPTION OF THE PREFERRED EMBODIMENTS

### System Overview:

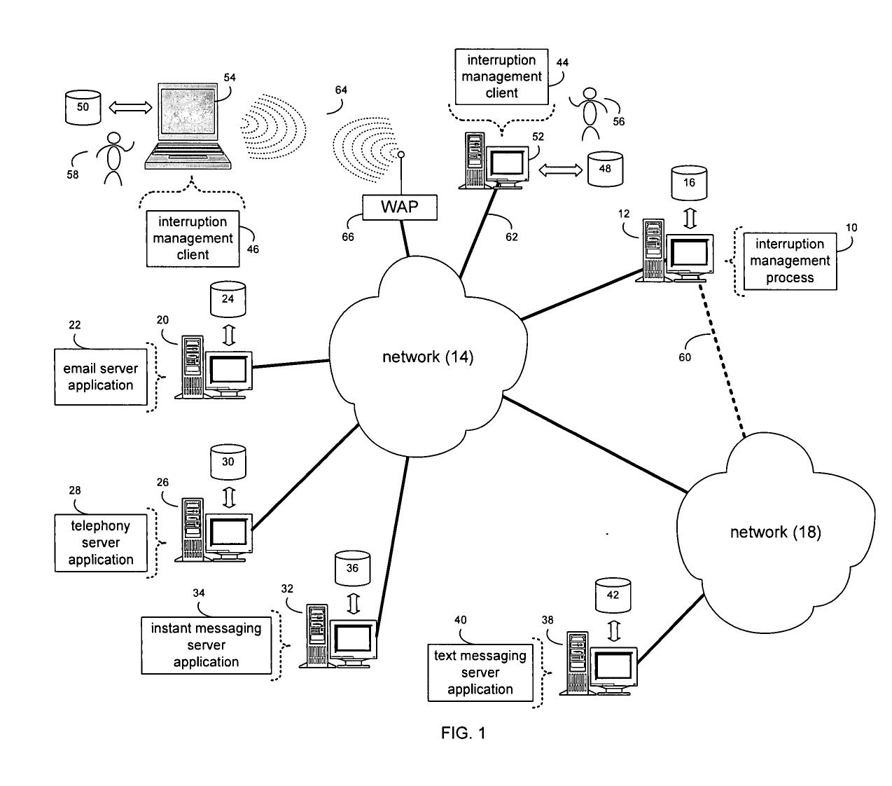

Referring to FIG. 1, there is shown interruption management process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, interruption management process 10 may determine that a user of a client electronic device is in do-not-interrupt mode and may route messages directed to the user to a server-based storage queue for subsequent delivery.

The instruction sets and subroutines of interruption management process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

One or more additional server computers may be coupled to network 14 (or network 18) and may perform various functions. For example, email server computer 20 may execute email server application 22 (e.g., Lotus Domino™ Server and Microsoft Exchange™ Server), the instruction sets and subroutines of which may be stored on storage device 24 coupled to email server computer 22. These instruction sets and subroutines may be executed by one or more processors (not shown) and one or more memory architectures (not shown) incorporated into email server computer 20. Storage device 24 may include but is not limited to: a hard disk drive; a tape drive; an optical drive; a RAID array; a random access memory (RAM); and a read-only memory (ROM).

Telephony server computer 26 may execute telephony server application 28 (e.g., 3COM IP Telephony™ and Cisco IP Telephony™), the instruction sets and subroutines of which may be stored on storage device 30 coupled to telephony server computer 26. These instruction sets and subroutines may be executed by one or more processors (not shown) and one or more memory architectures (not shown) incorporated into telephony server computer 26. Storage device 30 may include but is not limited to: a hard disk drive; a tape drive; an optical drive; a RAID array; a random access memory (RAM); and a read-only memory (ROM).

Instant messaging server computer 32 may execute instant messaging server application 34 (e.g., Lotus Sametime™ and Microsoft Live Communication Server™), the instruction sets and subroutines of which may be stored on storage device 36 coupled to instant messaging server computer 32. These instruction sets and subroutines may be executed by one or more processors (not shown) and one or more memory architectures (not shown) incorporated into instant messaging server computer 32. Storage device 36 may include but is not limited to: a hard disk drive; a tape drive; an optical drive; a RAID array; a random access memory (RAM); and a read-only memory (ROM).

Text messaging server computer 38 may execute text messaging server application 40 (e.g., Blackberry Enterprise Server™), the instruction sets and subroutines of which may be stored on storage device 42 coupled to text messaging server computer 38. These instruction sets and subroutines may be executed by one or more processors (not shown) and one or more memory architectures (not shown) incorporated into text messaging server computer 38. Storage device 42 may include but is not limited to: a hard disk drive; a tape drive; an optical drive; a RAID array; a random access memory (RAM); and a read-only memory (ROM).

The instruction sets and subroutines of interruption management client applications 44, 46, which may be stored on storage devices 48, 50 (respectively) coupled to client electronic devices 52, 54 (respectively), may be executed by one or more processors (not shown) and one or more memory architectures (not shown) incorporated into client electronic devices 52, 54 (respectively). As will be discussed below in greater detail, interruption management client applications 44, 46 may allow the users of the client electronic devices on which these applications are executed to configure the manner in which interruption management process 10 operates.

Examples of storage devices 48, 50 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 52, 54 may include, but are not limited to, personal computer 52, laptop computer 54, a personal digital assistant (not shown), a notebook computer (not shown), a data-enabled, cellular telephone (not shown), and a dedicated network device (not shown), for example.

As will be discussed below in greater detail, interruption management client applications 44, 46 (each of which interfaces with interruption management process 10) may allow users 56, 58 (respectively) to define one or more rules that manage interruptions concerning e.g., email messages, telephone calls, instant messages, and text messages received during certain modes of operation of e.g., client electronic devices 52, 54.

Users 56, 58 may access interruption management process 10 (via interruption management client applications 44, 46 respectively) directly through network 14 or through secondary network 18. Further, server computer 12 (i.e., the computer that executes interruption management process 10) may be connected to network 14 through secondary network 18, as illustrated with phantom link line 60.

The various client electronic devices may be directly or indirectly coupled to network 14 (or network 18). For example, personal computer 52 is shown directly coupled to network 14 via hardwired network connection 62. Laptop computer 54 is shown wirelessly coupled to network 14 via wireless communication channel 64 established between laptop computer 54 and wireless access point (i.e., WAP) 66, which is shown directly coupled to network 14. WAP 66 may be, for example, an IEEE 802.11a, 802.11b, 802.11g, Wi-Fi, and/or Bluetooth device that is capable of establishing wireless communication channel 64 between laptop computer 54 and WAP 66.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 52, 54 may each execute an operating system, examples of which may include but are not limited to Microsoft Windows™, Microsoft Windows CE™, Redhat Linux™, or a custom operating system.

### The Interruption Management Process:

As discussed above, interruption management client applications 44, 46 (each of which interfaces with interruption management process 10) may allow users 56, 58 (respectively) to define one or more rules that manage interruptions concerning email messages, telephone calls, instant messages, and text messages received during certain modes of operation of e.g., client electronic devices 52, 54.

Interruption management plays an important role with respect to productivity. And as interruptions are minimized, productivity may increase. Examples of interruptions may include, but are not limited to: receiving email messages, receiving telephone calls, receiving instant messages, and receiving text messages. Further, interruptions during the occurrence of certain events may be more intrusive than during other times. For example, receiving a telephone call while in the middle of a meeting or a presentation may be highly intrusive. Further, as certain events result in popup windows being rendered on e.g., the computer screen of personal computer 52, in the event that user 56 is given a network-based presentation on computer 52 (or sharing the computer screen of computer 52), the rendering of a popup window (e.g., indicating the receipt of an email or an instant message) on the computer screen of personal computer 52 may result in that popup window being displayed to all of the viewers of the network-based presentation.

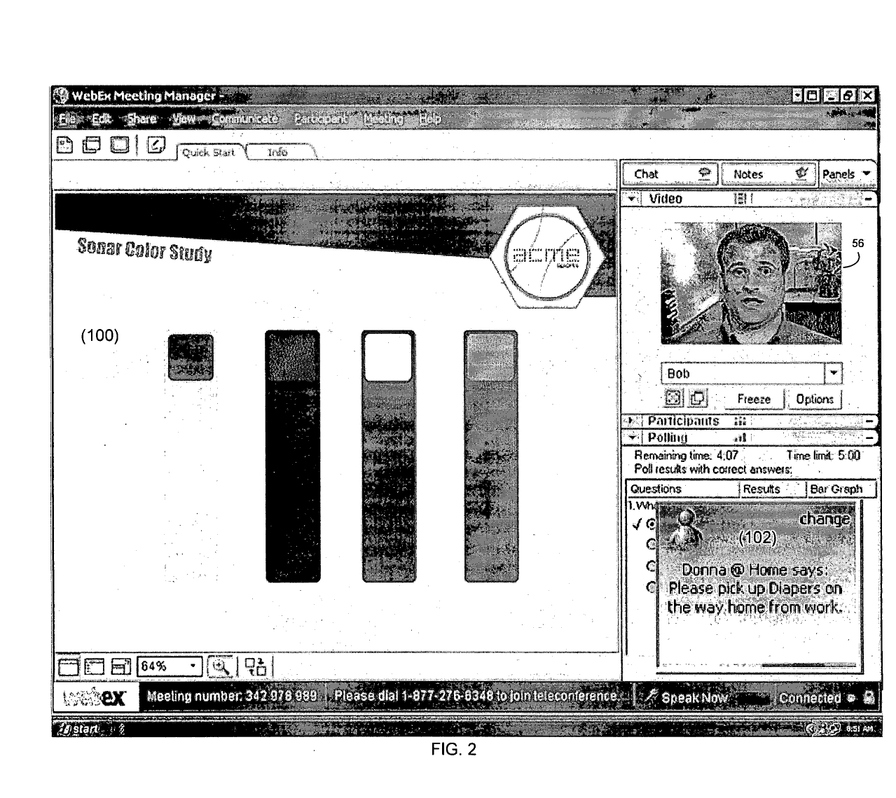

For example and referring also to FIG. 2, assume that user 56 is running a desktop sharing application (e.g. WebEx™) to give a presentation to a plurality of coworkers on a project team. Further, assume that during the presentation, the wife of user 56 sends an instant message to user 56 asking user 56 to “Please pick up Diapers on the way home from work”. The instant messaging program used by user 56 may render an on-screen indicator 102 concerning the instant message sent to user 56. As user 56 is in presentation mode, on-screen indicator 102 may be broadcast to all members of the project team.

Additionally, user 56 may experience other types of onscreen interruptions. For example, if user 56 receives an email message, a visual indicator (not shown) concerning the e-mail message sent to user 56 may be rendered on the screen of personal computer 52 and broadcast to all members of the project team. Further, if user 56 receives a text message, a visual indicator (not shown) concerning the text message sent to user 56 may be rendered on the screen of personal computer 52 and broadcast to all members of the project team. Additionally, if user 56 receives a voice phone call in the office from which user 56 is performing the presentation and if user 56 is transmitting audio, the ringing of the telephone (not shown) within the office of user 56 may be broadcast to all members of the project team.

Accordingly, it is desirable to minimize the amount of interruptions that occur while the user of a client electronic device is performing certain operations, such as giving presentations to team members.

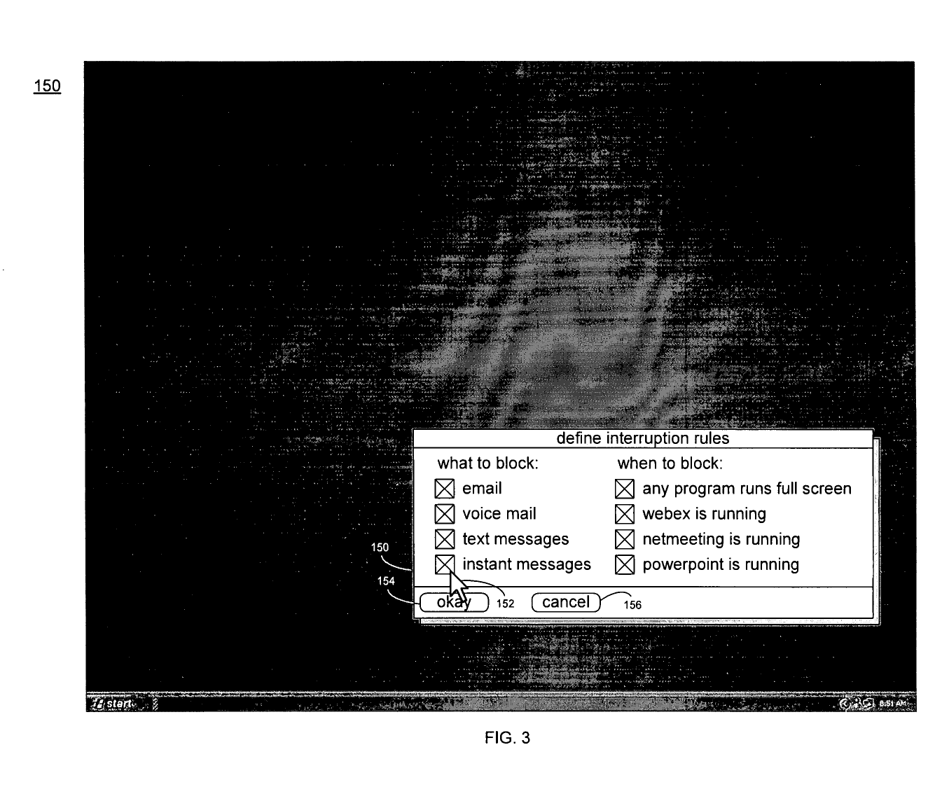

Referring also to FIG. 3, users of various client electronic devices (such as user 56 of personal computer 52 and user 58 of laptop computer 54) may utilize interruption management client (e.g. interruption management client application 44 on personal computer 52 and interruption management client application 46 on laptop computer 54) to configure what (if any) interruptions are allowed while the user of the client electronic device is performing certain functions.

While the following discussion is limited to interruption management client application 44 executed on personal computer 52, this is for illustrative purposes only and is not intended to be a limitation of this disclosure, as the following discussions may be equally applied to both interruption management client application 44 executed on personal computer 52 and interruption management client application 46 executed on laptop computer 54.

Interruption management client application 44 may render configuration window 150 on the display screen of personal computer 52, which allows user 56 to configure the manner in which interruption management process 10 operates. Configuration window 150 of interruption management client application 44 may allow the user to define what particular interruptions they wish to block and when they wish to block these particular interruptions.

For example, configuration window 150 is shown to include, under the heading “what to block”, four selectable entries namely: “e-mail”; “voicemail”; “text messages”; and “instant messages”. Accordingly, if user 56 does not wish to be interrupted with instant messages when performing presentations, user 56 may simply select the selectable box next to the “instant messages” entry using onscreen pointer 152 which is controllable by a pointing device (e.g. a mouse; not shown).

Additionally, configuration window 150 is shown to include, under the heading “when to block” four selectable entries namely: “any program runs full screen”; “WebEx is running”; “NetMeeting is running”; and “PowerPoint is running”. Accordingly, if user 56 does not wish to be interrupted when WebEx is running, user 56 may simply select the selectable box next to the “WebEx is running” entry using onscreen pointer 152 which is controllable by a pointing device (e.g. a mouse; not shown).

While configuration window 150 is shown to include four entries concerning “what to block” and four entries concerning “when to block”, this is for illustrative purposes only and is not intended to be a limitation of this disclosure. Specifically, the exact number of entries under “what to block” and/or the exact number of entries under “when to block” may be adjusted based upon e.g. design criteria and program capabilities.

Assume for illustrative purposes that user 56 wants to minimize the amount of interruptions that are experienced during as many situations as possible. Accordingly, user 56 may choose to select all entries under “what to block” and may choose to select all entries under “when to block” (as shown in FIG. 3). Once user 56 has selected all the appropriate entries, user 56 may select “okay” button 154 using onscreen pointer 152. Alternatively, user 56 may select “cancel” button 156 to close configuration window 150.

Assuming the user 56 selects “okay” button 154 using onscreen pointer 152, interruption management client application 44 may provide information concerning the interruption types to be blocked and the times at which those interruption types will be blocked to interruption management process 10. Once received, interruption management process 10 may be configured to block the specific interruption types during the specific times defined by user 56. Additionally, interruption management process 10 may provide the appropriate information to other computers as needed, such as: e-mail server computer 20 which may execute e-mail server application 22; telephony server computer 26 which may execute telephony server application 28; instant messaging server computer 32 which may execute instant messaging server application 34; and text messaging server application 38 which may execute text messaging server application 40.

While interruption management process 10 is described above as being configured using interruption management client application 44, this is for illustrative purposes only and is not intended to be a limitation of this disclosure. Specifically and as discussed above, server computer 12 (i.e. the computer that executes interruption management process 10) may execute a web server application. Accordingly, interruption management process 10 may be configured via a webpage served by the above-described Web server application.

Once properly configured, interruption management process 10 may manage the amount of times user 56 is interrupted by managing the specific types of interruptions that are allowed and the specific times during which these interruptions are allowed. Interruption management client application 44 may determine 200 whether or not user 56 is operating personal computer 52 in do-not-interrupt mode. Do-not-interrupt mode may be defined as the computer operating during one of the above-described times during which interruption should be blocked.

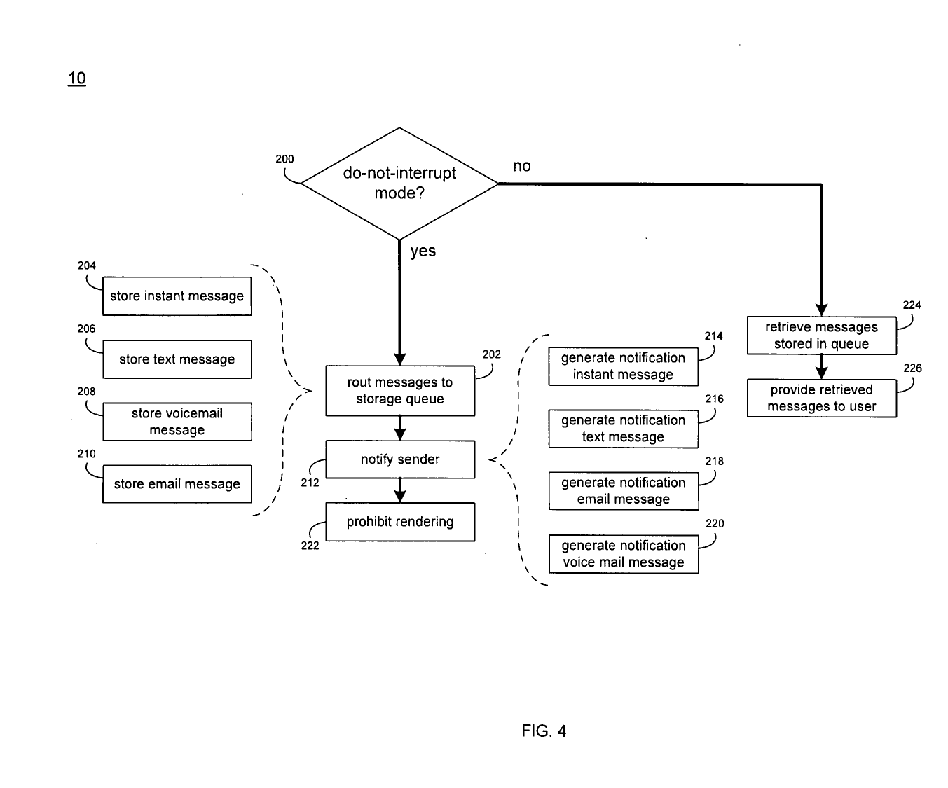

Continuing with the above-stated example, user 56 does not wish to be interrupted when: “any program runs full screen”; “WebEx is running”; “NetMeeting is running”; and “PowerPoint is running”. Accordingly and referring also to FIG. 4, whenever personal computer 52 is operating in one of these four modes, interruption management client application 44 may provide information concerning the mode of operation of personal computer 52 to interruption management process 10. Interruption management process 10 may use this information to determine 200 that personal computer 52 is in do-not-interrupt mode. Once this determination 200 is made, interruption management process 10 may route 202 messages that meet the criteria defined within configuration window 150 to a server-based storage queue for subsequent delivery. The specific type of server-based storage queue to which the messages are routed 202 will vary depending on the type of message.

Continuing with the above-stated example, as user 56 wishes to have all interruptions (e.g. “e-mail”; “voicemail”; “text messages”; and “instant messages”) blocked, all of these messages will be routed 202 to various server-based storage queues. As discussed above, server computer 12 (i.e. the computer that executes interruption management process 10) may be coupled to server computers 20, 26, 32, 38 (i.e. the computers that execute e-mail server application 22, telephony server application 28, instant messaging server application 34 and text messaging server application 40). Accordingly, upon determining 200 that user 56 is in do-not-interrupt mode, interruption management process 10 may instruct mail server application 22, telephony server application 28, instant messaging server application 34 and text messaging server application 40 to prevent propagation of messages to personal computer 52.

Accordingly, when the message to be transmitted is an instant message, routing 202 the message to a server-based storage queue for subsequent delivery may include storing 204 the instant message in an instant message server-based storage queue controlled by instant messaging server application 34 and included within e.g. storage device 36 that is coupled to instant messaging server 32. Therefore, in the event that personal computer 52 is in do-not-interrupt mode at the time that an instant message for user 56 is received by instant messaging server application 34, instant messaging server application 34 may not forward the instant message to user 56 and, instead, the instant message may be stored 204 within an instant message server-based storage queue included within storage device 36 for subsequent delivery to user 56.

Further, when the message to be transmitted is a text message, routing 202 the message to a server-based storage queue for subsequent delivery may include storing 206 the text message in a text message server-based storage queue controlled by text message server application 40 and included within e.g. storage device 42 that is coupled to text messaging server 38. Therefore, in the event that personal computer 52 is in do-not-interrupt mode at the time that a text message for user 56 is received by text messaging server application 40, text messaging server application 40 may not forward the text message to user 56 and, instead, a text message may be stored 206 within a text message server-based storage queue included within storage device 42 for subsequent delivery to user 56.

Additionally, when the message to be transmitted is a voicemail message, routing 202 the message to a server-based storage queue for subsequent delivery may include storing 208 the voicemail message in a voicemail message server-based storage queue controlled by telephony server application 28 and included within storage device 30 that is coupled to telephony server 26. Therefore, in the event that personal computer 52 is in do-not-interrupt mode at the time that a voice call for user 56 is received by telephony server application 28, telephony server application 28 may not route the voice call to the telephone (not shown) of user 56 and, instead, the voice call may be stored 208 within a voicemail server-based storage queue included within storage device 30 for subsequent delivery to user 56.

Further, when the message to be transmitted is an email message, routing 202 the message to a server-based storage queue for subsequent delivery may include storing 210 the email message in an inbox of an email system controlled by e-mail server application 22 and included within storage device 24 that is coupled to e-mail server 20. Therefore, in the event that personal computer 52 is in do-not-interrupt mode at the time that an e-mail message for user 56 is received by e-mail server application 22, e-mail server application 22 may not forward the e-mail message to user 56 and, instead, the e-mail message may be stored 210 within an e-mail message server-based storage queue included within storage device 24 for subsequent delivery to user 56.

In the event that a message is queued by interruption management process 10 for subsequent delivery to e.g. user 56, the sender of the message may be notified 212 that user 56 is in do-not-interrupt mode.

For example, if the message received is an instant message, notifying 212 the sender of the instant message may include generating 214 a notification instant message and providing the notification instant message to the sender of the instant message that was directed to user 56, informing the sender that user 56 is in do-not-interrupt mode. Accordingly, the sender of the instant message may receive a reply instant message that says “The intended recipient of this instant message cannot be interrupted now but, as this message is being stored for later review, will respond to this message as soon as possible”.

Further, if the message received is a text message, notifying 212 the sender of the text message may include generating 216 a notification text message and providing the notification text message to the sender of the text message that was directed to user 56, informing the sender that user 56 is in do-not-interrupt mode. Accordingly, the sender of the text message may receive a reply text message that says “The intended recipient of this text message cannot be interrupted now but, as this message is being stored for later review, will respond to this message as soon as possible”.

Additionally, if the message received is an email message, notifying 212 the sender of the email message may include generating 218 a notification email message and providing the notification email message to the sender of the email message directed to user 56, informing the sender that user 56 is in do-not-interrupt mode. Accordingly, the sender of the email message may receive a reply email message that says “The intended recipient of this email message cannot be interrupted now but, as this message is being stored for later review, will respond to this message as soon as possible”.

Further, if the message received is a voice call, notifying 212 the sender of the voice call may include generating a notification voice mail message and providing the notification voice mail message to the sender of the message directed to user 56, informing the sender that user 56 is in do-not-interrupt mode. Accordingly, the sender of the voice call may be immediately directed to a voice mail system which may say “The intended recipient of this voice call cannot be interrupted now but please leave a voice mail message and they will respond to your message as soon as possible”.

Accordingly, through the use of interruption management process 10 and interruption management client application 44, user 56 may prohibit 222 the rendering of onscreen indicators (e.g., text message received onscreen indicators; instant message received onscreen indicators; and email received onscreen indicators) associated with the messages (e.g. instant messages, text messages, and e-mail messages) directed toward user 56 while user 56 is in do-not-interrupt mode (as defined above).

As discussed above, interruption management client application 44 may determine whether or not user 56 is operating personal computer 52 in do-not-interrupt mode, and do-not-interrupt mode may be defined as the computer operating in one of the above-described manners during which interruptions should be blocked. Accordingly, when user 56 is not operating personal computer 52 in do-not-interrupt mode, interruption management client application 44 may notify interruption management process 10 and interruption management process 10 may once again allow the rendering of onscreen indicators (e.g., text message received onscreen indicators; instant message received onscreen indicators; and email received onscreen indicators) associated with the messages (e.g. instant messages, text messages, and e-mail messages) directed toward user 56.

Further and as discussed above, messages that meet the criteria defined above (via configuration window 150) are routed 202 to a server-based storage queue for subsequent delivery to user 56. Accordingly, once it is determined 200 that personal computer 52 is no longer operating in do-not-interrupt mode, one or more messages stored in the above-described server-based storage queue may be retrieved 224, and these retrieved messages may be provided 226 to the user.

For example, once computer 52 is no longer operating in do-not-interrupt mode, the instant messages stored 204 within instant message server-based storage queue (i.e., which is controlled by instant messaging server application 34 and included within e.g. storage device 36) may be retrieved 224 from the instant message server-based storage queue and provided 226 to user 56, thus allowing user 56 to e.g. respond to the instant messages received while in do-not-interrupt mode.

Further, once computer 52 is no longer operating in do-not-interrupt mode, the text messages stored 206 within text message server-based storage queue (i.e., which is controlled by text messaging server application 40 and included within e.g. storage device 42) may be retrieved 224 from the text message server-based storage queue and provided 226 to user 56, thus allowing user 56 to e.g. respond to the text messages received while in do-not-interrupt mode.

Additionally, once computer 52 is no longer operating in do-not-interrupt mode, the voice mail messages stored 208 within voice mail message server-based storage queue (i.e., which is controlled by telephony server application 28 and included within e.g. storage device 30) may be retrieved 224 from the voice mail server-based storage queue and provided 226 to user 56, thus allowing user 56 to e.g. respond to the voice mail messages received while in do-not-interrupt mode.

Further, once computer 52 is no longer operating in do-not-interrupt mode, the email messages stored 210 within email message server-based storage queue (i.e., which is controlled by email server application 22 and included within e.g. storage device 24) may be retrieved 224 from the email message server-based storage queue and provided 226 to user 56, thus allowing user 56 to e.g. respond to the email messages received while in do-not-interrupt mode.

A number of implementations have been described. Nevertheless, it will be understood that various modifications may be made. Accordingly, other implementations are within the scope of the following claims.

What is claimed is:

1. A method comprising:
determining that a user of a client electronic device is in do-not-interrupt mode; and
routing a message directed to the user to a server-based storage queue for subsequent delivery.

2. The method of claim 1 wherein the message is an instant message and routing a message directed to the user to a server-based storage queue for subsequent delivery includes:
storing the instant message in an instant message server-based storage queue.

3. The method of claim 1 wherein the message is a text message and routing a message directed to the user to a server-based storage queue for subsequent delivery includes:
storing the text message in a text message server-based storage queue.

4. The method of claim 1 wherein the message is a voicemail message and routing a message directed to the user to a server-based storage queue for subsequent delivery includes:
storing the voicemail message in a voicemail message server-based storage queue.

5. The method of claim 1 wherein the message is an email message and routing a message directed to the user to a server-based storage queue for subsequent delivery includes:
storing the email message in an inbox of an email system.

6. The method of claim 1 further comprising:
notifying a sender of the message directed to the user that the user of the client electronic device is in do-not-interrupt mode.

7. The method of claim 6 wherein notifying a sender includes one or more of:
generating a notification instant message and providing the notification instant message to the sender of the message directed to the user;
generating a notification text message and providing the notification text message to the sender of the message directed to the user;
generating a notification email message and providing the notification email message to the sender of the message directed to the user; and
generating a notification voice mail message and providing the notification voice mail message to the sender of the message directed to the user.

8. The method of claim 1 further comprising:
determining that the user of the client electronic device is no longer in do-not-interrupt mode;
retrieving one or more messages stored in the server-based storage queue, thus defining one or more retrieved messages; and
providing the one or more retrieved messages to the user.

9. The method of claim 1 further comprising:
prohibiting the rendering of an onscreen indicator associated with the message directed to the user while the user is in do-not-interrupt mode.

10. The method of claim 9 wherein the onscreen indicator is chosen from the group consisting of: a text message received onscreen indicator; an instant message received onscreen indicator; and an email received onscreen indicator.

11. A computer program product residing on a computer readable medium having a plurality of instructions stored thereon which, when executed by a processor, cause the processor to perform operations comprising:
determining that a user of a client electronic device is in do-not-interrupt mode; and
routing a message directed to the user to a server-based storage queue for subsequent delivery.

12. The computer program product of claim 11 wherein the message is an instant message and the instructions for routing a message directed to the user to a server-based storage queue for subsequent delivery include instructions for:
storing the instant message in an instant message server-based storage queue.

13. The computer program product of claim 11 wherein the message is a text message and the instructions for routing a message directed to the user to a server-based storage queue for subsequent delivery include instructions for:
storing the text message in a text message server-based storage queue.

14. The computer program product of claim 11 wherein the message is a voicemail message and the instructions for routing a message directed to the user to a server-based storage queue for subsequent delivery include instructions for:
storing the voicemail message in a voicemail message server-based storage queue.

15. The computer program product of claim 11 wherein the message is an email message and the instructions for routing a message directed to the user to a server-based storage queue for subsequent delivery include instructions for:
storing the email message in an inbox of an email system.

16. The computer program product of claim 11 further comprising instructions for:
notifying a sender of the message directed to the user that the user of the client electronic device is in do-not-interrupt mode.

17. The computer program product of claim 16 wherein the instructions for notifying a sender includes instructions for one or more of:
generating a notification instant message and providing the notification instant message to the sender of the message directed to the user;
generating a notification text message and providing the notification text message to the sender of the message directed to the user;
generating a notification email message and providing the notification email message to the sender of the message directed to the user; and
generating a notification voice mail message and providing the notification voice mail message to the sender of the message directed to the user.

18. The computer program product of claim 11 further comprising instructions for:
determining that the user of the client electronic device is no longer in do-not-interrupt mode;
retrieving one or more messages stored in the server-based storage queue, thus defining one or more retrieved messages; and
providing the one or more retrieved messages to the user.

19. The computer program product of claim 11 further comprising instructions for:
prohibiting the rendering of an onscreen indicator associated with the message directed to the user while the user is in do-not-interrupt mode.

20. The computer program product of claim 19 wherein the onscreen indicator is chosen from the group consisting of: a text message received onscreen indicator; an instant message received onscreen indicator; and an email received onscreen indicator.
